(19) United States
(12) Patent Application Publication
(10) Pub. No.: US 2015/0168786 A1
(43) Pub. Date: Jun. 18, 2015

(54) DISPLAY DEVICE AND MANUFACTURING METHOD THEREOF

(71) Applicant: SAMSUNG DISPLAY CO., LTD., Yongin-si (KR)

(72) Inventors: Seon Uk LEE, Seongnam-si (KR); Won Tae KIM, Suwon-si (KR); Yong Seok KIM, Seoul (KR); Dae Ho SONG, Hwaseong-si (KR); Sung Hwan WON, Suwon-si (KR)

(73) Assignee: SAMSUNG DISPLAY CO., LTD., Yongin-City (KR)

(21) Appl. No.: 14/288,223

(22) Filed: May 27, 2014

(30) Foreign Application Priority Data
Dec. 12, 2013 (KR) 10-2013-0154948 A

(51) Int. Cl. G02F 1/1343; G02F 1/1334

(52) U.S. Cl. CPC G02F 1/134309; G02F 1/1334

(57) ABSTRACT

A display device is provided. The display device includes: a substrate; a thin film transistor disposed on the substrate; a pixel electrode connected to the thin film transistor; a first common electrode disposed on the pixel electrode, and spaced apart from the pixel electrode with a microcavity disposed therebetween; an injection hole exposing a portion of the microcavity; a liquid crystal layer filling the microcavity; an encapsulation layer covering the injection hole so as to encapsulate the microcavity; and a second common electrode disposed on the first common electrode and the encapsulation layer, wherein the second common electrode is connected to the first common electrode.

### CROSS-REFERENCE TO RELATED APPLICATION

This application claims priority to and the benefit of Korean Patent Application No. 10-2013-0154948 filed in the Korean Intellectual Property Office on Dec. 12, 2013, the entire contents of which are incorporated herein by reference.

### BACKGROUND

(a) Technical Field

The present disclosure relates to a display device and a manufacturing method thereof. More particularly, the present disclosure relates to a display device having a common electrode with a lower resistance and improved horizontal cross-talk.

(b) Description of the Related Art

A liquid crystal display is widely used in flat panel displays. A liquid crystal display typically includes two sheets of display panels in which field generating electrodes (such as a pixel electrode and a common electrode) are formed and a liquid crystal layer interposed therebetween. A voltage is applied to the field generating electrode to generate an electric field in the liquid crystal layer. The electric field determines an orientation of liquid crystal molecules in the liquid crystal layer and controls polarization of incident light through the liquid crystal layer, thereby displaying an image.

The two sheets of display panels in the liquid crystal display may include a thin film transistor array panel and a counter display panel. The thin film transistor array panel may include gate lines (for transferring gate signals) and data lines (for transferring data signals) intersecting with each other. The thin film transistor array panel may further include thin film transistors connected to the gate lines and the data lines, pixel electrodes connected to the thin film transistors, and the like. The counter display panel may include a light blocking member, a color filter, a common electrode, and the like. In some cases, the light blocking member, the color filter, and the common electrode may be formed on the thin film transistor array panel instead of the counter display panel.

In a conventional liquid crystal display, the two display panels are typically formed on two separate substrates. For example, a first substrate is used for the thin film transistor array panel, and a second substrate is used for the opposing display panel. However, using two separate substrates for the display panels increases the weight and form factor of the liquid crystal display device, as well as process costs and turn-around time.

The above information disclosed in this Background section is only for enhancement of understanding of the background of the disclosure and therefore it may contain information that does not form the prior art that is already known in this country to a person of ordinary skill in the art.

### SUMMARY

The present disclosure provides a method of manufacturing a display device using a single substrate, which allows the weight, form factor, and costs of the display device to be reduced.

The present disclosure further provides a display device having a common electrode with a lower resistance and improved horizontal cross-talk.

According to some embodiments of the inventive concept, a display device is provided. The display device includes: a substrate; a thin film transistor disposed on the substrate; a pixel electrode connected to the thin film transistor; a first common electrode disposed on the pixel electrode, and spaced apart from the pixel electrode with a microcavity disposed therebetween; an injection hole exposing a portion of the microcavity; a liquid crystal layer filling the microcavity; an encapsulation layer covering the injection hole so as to encapsulate the microcavity; and a second common electrode disposed on the first common electrode and the encapsulation layer, wherein the second common electrode is connected to the first common electrode.

In some embodiments, the microcavity may be disposed in a matrix to form a plurality of microcavities, a first valley may be formed between the micro cavities adjacent to each other in a column direction, and a second valley may be formed between the micro cavities adjacent to each other in a row direction.

In some embodiments, the encapsulation layer may be disposed in the first valley.

In some embodiments, the encapsulation layer may be disposed overlapping an edge of the microcavity.

In some embodiments, the encapsulation layer may not overlap the microcavity other than the edge of the microcavity.

In some embodiments, the encapsulation layer may not overlap a central portion of the microcavity.

In some embodiments, the first common electrode and the second common electrode may be connected to each other at a portion overlapping the microcavity.

In some embodiments, the encapsulation layer may be disposed in the second valley.

In some embodiments, the display device may further include a roof layer disposed between the first common electrode and the encapsulation layer.

In some embodiments, the roof layer may include at least one of silicon nitride and silicon oxide.

Another to some other embodiments of the inventive concept, a method of manufacturing a display device is provided. The method includes: forming a thin film transistor on a substrate; forming a pixel electrode, wherein the pixel electrode is connected to the thin film transistor; forming a sacrificial layer on the pixel electrode; forming a first common electrode on the sacrificial layer; patterning the first common electrode so as to expose a portion of the sacrificial layer; forming a microcavity by removing the sacrificial layer, wherein a portion of the microcavity is exposed between the common electrode and the pixel electrode; forming a liquid crystal layer by injecting a liquid crystal material into the microcavity through the exposed portion of the microcavity; forming an encapsulation layer to cover the exposed portion of the microcavity, so as to encapsulate the microcavity; patterning the encapsulation layer to expose at least a portion of the first common electrode; and forming a second common electrode on the first common electrode and the encapsulation layer.

In some embodiments, the microcavity may be disposed in a matrix to form a plurality of microcavities, a first valley may be formed between the micro cavities adjacent to each other in a column direction, and a second valley may be formed between the micro cavities adjacent to each other in a row direction.

In some embodiments, the encapsulation layer may be patterned such that a portion of the encapsulation layer located in the first valley remains.

In some embodiments, the encapsulation layer may be patterned such that a portion of the encapsulation layer overlapping an edge of the microcavity remains.

In some embodiments, the encapsulation layer may be patterned to remove a portion of the encapsulation layer overlapping the microcavity, other than the portion of the encapsulation layer overlapping the edge of the microcavity.

In some embodiments, the encapsulation layer may be patterned to remove a portion of the encapsulation layer overlapping a central portion of the microcavity.

In some embodiments, the first common electrode and the second common electrode may be connected to each other at a portion overlapping the microcavity.

In some embodiments, the encapsulation layer may be patterned such that a portion of the encapsulation layer located in the second valley remains.

In some embodiments, the method of manufacturing the display device may further include: forming a roof layer on the first common electrode; patterning the roof layer to expose a portion of the sacrificial layer; and patterning the roof layer by using the patterned encapsulation layer as a mask.

In some embodiments, the roof layer may include at least one of silicon nitride and silicon oxide.

### BRIEF DESCRIPTION OF THE DRAWINGS

FIG. 1 is a plan view of a display device according to an exemplary embodiment of the inventive concept.

FIG. 2 is a perspective view of the display device of FIG. 1.

FIG. 3 is an equivalent circuit diagram of a pixel of a display device according to an exemplary embodiment of the inventive concept.

FIG. 4 is a layout view of a portion of a display device according to an exemplary embodiment of the inventive concept.

FIG. 5 is a cross-sectional view of the display device of FIG. 4 taken along line V-V.

FIG. 6 is a cross-sectional view of the display device of FIG. 4 taken along line VI-VI.

FIGS. 7 to 9, 11, 13, and 15 are cross-sectional views illustrating a method of manufacturing a display device according to an exemplary embodiment of the inventive concept.

FIGS. 10, 12, 14, and 16 are perspective views of the display device of FIGS. 7 to 9, 11, 13, and 15 at different stages of manufacture.

FIG. 17 is a perspective view of a display device according to another exemplary embodiment of the inventive concept.

FIG. 18 is a plan view of the display device of FIG. 17.

FIG. 19 is a cross-sectional view of the display device of FIG. 18 taken along line XIX-XIX.

FIG. 20 is a cross-sectional view of a display device according to a further exemplary embodiment of the inventive concept.

### DETAILED DESCRIPTION

The inventive concept will be described more fully herein with reference to the accompanying drawings in which exemplary embodiments are shown. As those skilled in the art would realize, the described embodiments may be modified in various ways without departing from the spirit or scope of the present disclosure.

In the drawings, the thickness of layers, films, panels, regions, etc., may be exaggerated for clarity. Like reference numerals designate like elements throughout the specification. It will be understood that when an element such as a layer, film, region, or substrate is referred to as being “on” another element, it can be disposed directly on the other element, or with one or more intervening elements being present. In contrast, when an element is referred to as being “directly on” another element, there are no intervening elements present.

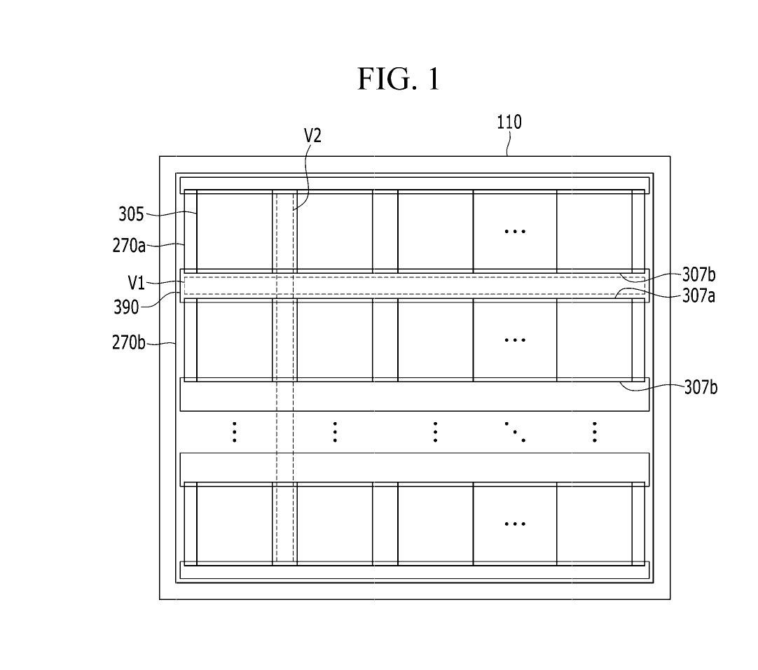

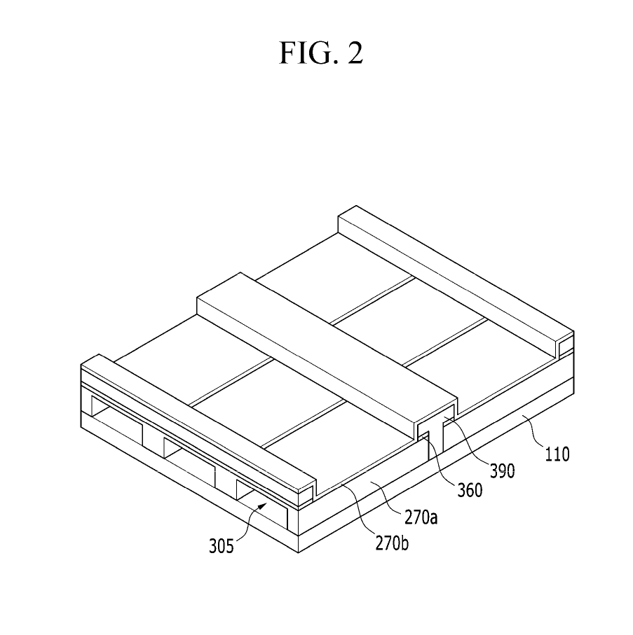

First, a display device according to an exemplary embodiment of the inventive concept will be described below in detail with reference to FIGS. 1 and 2.

FIG. 1 is a plan view of a display device according to an exemplary embodiment of the inventive concept, and FIG. 2 is a perspective view of the display device of FIG. 1.

Referring to FIGS. 1 and 2, the display device includes a substrate 110 formed of a material such as glass, plastic, and the like.

A microcavity 305 is formed on the substrate 110. A first common electrode 270a is formed covering the microcavity 305 and extends in a row direction.

The microcavity 305 may be disposed in a matrix to form a plurality of microcavities 305. A first valley V1 is disposed between the microcavities 305 adjacent to each other in a column direction, and a second valley V2 is disposed between the microcavities 305 adjacent to each other in a row direction. As shown in FIG. 2, the plurality of microcavities 305 are disposed under a plurality of first common electrodes 270a.

The plurality of first common electrodes 270a are separated from each other with the first valley V1 disposed therebetween. As such, the first common electrode 270a is not formed in the first valley V1. A portion of the edges of the microcavity 305 is not covered by the first common electrode 270a. For example, a side of the microcavity 305 adjacent to the first valley V1 may be exposed. That is, the sides of two opposite edges of the microcavity 305 facing each other may be exposed to form injection holes 307a and 307b. Accordingly, a microcavity 305 may be formed with the two injection holes 307a and 307b. However, the inventive concept is not limited thereto. For example, in some embodiments, only one injection hole may be formed in one microcavity 305. In some other embodiments, three or more injection holes may be formed in one microcavity 305.

The first common electrodes 270a are formed between adjacent second valleys V2 and spaced apart from the substrate 110, thereby forming the microcavity 305. That is, the first common electrode 270a is formed covering the edges of the microcavity 305 (except the edges at which the injection holes 307a and 307b are formed). For example, the first common electrode 270a may be formed covering the left edge and the right edge of the microcavity 305.

An encapsulation layer 390 is formed over the first valley V1 covering the injection holes 307a and 307b, so as to encapsulate the microcavity 305. The encapsulation layer 390 may be formed in a bar shape along the first valley V1. The encapsulation layer 390 may partially overlap the first common electrode 270a and fully overlap an edge of the microcavity 305. However, the encapsulation layer 390 only overlaps the microcavity 305 at the edge of the microcavity 305. As such, the encapsulation layer 390 does not overlap a central portion of the microcavity 305.

A second common electrode 270b is formed on the first common electrode 270a and the encapsulation layer 390. The first common electrode 270a and the second common electrode 270b are connected to each other at a portion overlapping the microcavity 305. Specifically, the second common electrode 270b is formed on the first common electrode 270a at the portion overlapping the microcavity 305, and is thus connected to the first common electrode 270a.

A roof layer 360 is formed on the first common electrode 270a. The roof layer 360 is formed overlapping the first common electrode 270a at the edge of the microcavity 305. The roof layer 360 may be formed at the edge of the microcavity 305 where the injection holes 307a and 307b are formed. For example, the roof layer 360 may be formed at the upper edge and the lower edge of the microcavity 305, but is not formed at the central portion of the microcavity 305.

It should be noted that the structure of the display device described above with reference to FIGS. 1 and 2 is merely exemplary and can be modified in various ways. The configurations of the microcavity 305, the first valley V1, and the second valley V2 may be changed. For example, in some other embodiments, the plurality of first common electrodes 270a may be connected to each other at the first valley V1, and a portion of each of the first common electrodes 270a is formed at the second valley V2 separated from the substrate 110. Accordingly, adjacent microcavities 305 in those other embodiments may be connected to each other.

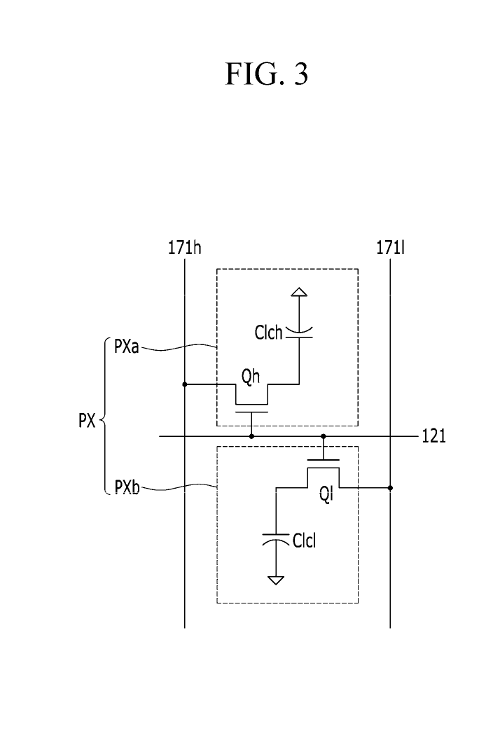

Next, a pixel of the display device according to an exemplary embodiment of the inventive concept will be described with reference to FIG. 3.

FIG. 3 is an equivalent circuit diagram of a pixel of a display device according to an exemplary embodiment of the inventive concept.

Referring to FIG. 3, the display device includes a plurality of signal lines 121, 171h, and 171l and a plurality of pixels PXs connected thereto. The plurality of pixels PXs may be disposed as a matrix comprising a plurality of pixel rows and a plurality of pixel columns.

Each of the pixels PXs may include a first subpixel PXa and a second subpixel PXb. The first subpixel PXa and the second subpixel PXb may be vertically disposed, such that the first valley V1 may be disposed between the first subpixel PXa and the second subpixel PXb along a pixel row direction, and the second valley V2 may be disposed between the plurality of pixel columns.

The signal lines include the gate line 121 (for transferring a gate signal) and the first data line 171h and the second data line 171l (for transferring different data voltages).

A first switching element Qh is connected to the gate line 121 and the first data line 171h, and a second switching element Ql is connected to the gate line 121 and the second data line 171l.

The first subpixel PXa further includes a first liquid crystal capacitor Clch connected to the first switching element Qh. Similarly, the second subpixel PXb further includes a second liquid crystal capacitor Clcl connected to the second switching element Ql.

The first switching element Qh includes a first terminal connected to the gate line 121, a second terminal connected to the first data line 171h, and a third terminal connected to the first liquid crystal capacitor Clch.

The second switching element Ql includes a first terminal connected to the gate line 121, a second terminal connected to the second data line 171l, and a third terminal connected to the second liquid crystal capacitor Clcl.

The liquid crystal display according to an exemplary embodiment of the inventive concept may operate as follows. When a gate-on voltage is applied to the gate line 121, the first switching element Qh and the second switching element Ql (which are both connected to the gate line 121) are switched on, and the first and second liquid crystal capacitors Clch and Clcl are then charged by different data voltages transferred through the first and second data lines 171h and 171l. In some instances, the data voltage transferred by the second data line 171l may be lower than the data voltage transferred by the first data line 171h. Therefore, the second liquid crystal capacitor Clcl may be charged with a voltage lower than that of the first liquid crystal capacitor Clch, which can improve side visibility.

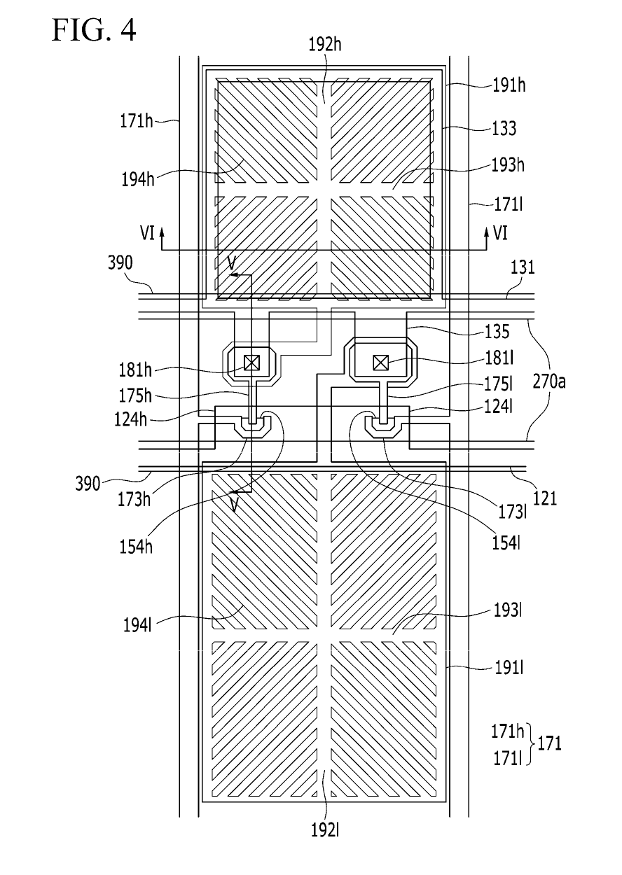

Next, the structure of a pixel of the liquid crystal display according to an exemplary embodiment of the inventive concept will be described with reference to FIGS. 4 to 6.

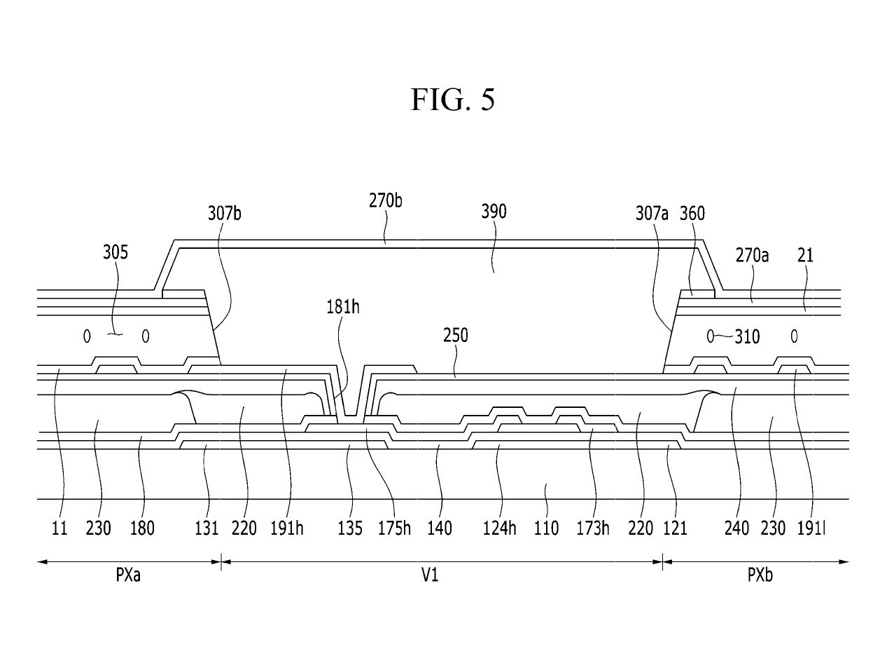

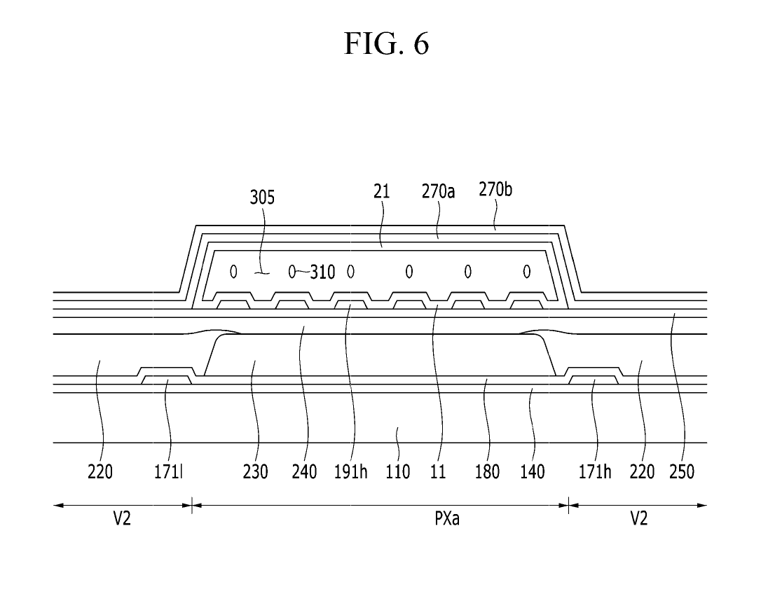

FIG. 4 is a layout view of a portion of a display device according to an exemplary embodiment of the inventive concept. FIG. 5 is a cross-sectional view of the display device of FIG. 4 taken along line V-V. FIG. 6 is a cross-sectional view of the display device of FIG. 4 taken along line VI-VI.

Referring to FIGS. 4 to 6, the gate line 121, and a first gate electrode 124h and a second gate electrode 124l protruding from the gate line 121, are formed on the substrate 110.

The gate line 121 extends in a substantially horizontal direction and transfers the gate signal. The gate line 121 is disposed between two microcavities 305 adjacent to each other in the column direction. The first gate electrode 124h and the second gate electrode 124l protrude from the gate line 121. The first gate electrode 124h and the second gate electrode 124l may be connected to each other to form a single protrusion. However, the inventive concept is not limited thereto. For example, the protrusion and shape of the first gate electrode 124h and the second gate electrode 124l may be modified in different embodiments.

A storage electrode line 131, and storage electrodes 133 and 135 protruding from the storage electrode line 131, may be further formed on the substrate 110.

The storage electrode line 131 extends in a direction substantially parallel with the gate line 121, and is spaced apart from the gate line 121. The storage electrode line 131 may be formed of a same material and on a same layer as the gate line 121. The storage electrode 133 protrudes over the storage electrode line 131 and surrounds an edge of the first subpixel area PXa. The storage electrode 135 protrudes under the storage electrode line 131, and is adjacent to the first gate electrode 124h and the second gate electrode 124l.

A gate insulating layer 140 is formed on the gate line 121, the first gate electrode 124h, the second gate electrode 124l, the storage electrode line 131, and the storage electrodes 133 and 135. The gate insulating layer 140 may be formed of an inorganic insulating material such as silicon nitride (SiNx), silicon oxide (SiOx), and the like. Further, the gate insulating layer 140 may be formed as a single layer or a multilayer structure.

A first semiconductor 154h and a second semiconductor 154l are formed on the gate insulating layer 140. The first semiconductor 154h may be disposed on the first gate electrode 124h and the second semiconductor 154l may be disposed on the second gate electrode 124l. The first semiconductor 154h may be formed under a first data line 171h and the second semiconductor 154l may be formed under a second data line 171l. The first semiconductor 154h and the second semiconductor 154l may be formed of amorphous silicon, polycrystalline silicon, metal oxide, and the like.

An ohmic contact member (not illustrated) may be formed on the first semiconductor 154h and the second semiconductor 154l. The ohmic contact member may be formed of silicide or a material doped with a high concentration of n-type impurity (such as n+ hydrogenated amorphous silicon).

The first data line 171h, a first source electrode 173h, and a first drain electrode 175h, are formed on the first semiconductor 154h and the gate insulating layer 140. The second data line 171l, a second source electrode 173l, and a second drain electrode 175l are formed on the second semiconductor 154l and the gate insulating layer 140.

The first data line 171h and the second data line 171l transfer data signals, and extend in a substantially vertical direction intersecting the gate line 121 and the storage electrode line 131. The data line 171 is disposed between two microcavities 305 adjacent to each other in the row direction.

The first data line 171h and the second data line 171l transfer different data voltages. In some embodiments, the data voltage transferred by the second data line 171l may be lower than the data voltage transferred by the first data line 171h. In some other embodiments, the data voltage transferred by the second data line 171l may be higher than the data voltage transferred by the first data line 171h.

The first source electrode 173h protrudes over the first gate electrode 124h from the first data line 171h. The second source electrode 173l protrudes over the second gate electrode 124l from the second data line 171l. Each of the first drain electrode 175h and the second drain electrode 175l includes a wide end and another bar-shaped end. The wide ends of the first drain electrode 175h and the second drain electrode 175l overlap with the storage electrode 135 protruding under the storage electrode line 131. The bar-shaped ends of the first drain electrode 175h and the second drain electrode 175l are each partially surrounded by the first source electrode 173h and the second source electrode 173l, respectively.

The first and second gate electrodes 124h and 124l, the first and second source electrodes 173h and 173l, the first and second drain electrodes 175h and 175l, together with the first and second semiconductors 154h and 154l, collectively constitute the first and second thin film transistors (TFTs) Qh and Ql, respectively. A channel of the first thin film transistor Qh is formed in the first semiconductor 154h and between the first source electrode 173h and the first drain electrode 175h. A channel of the second thin film transistor Ql is formed in the second semiconductor 154l and between the second source electrode 173l and the second drain electrode 175l.

A passivation layer 180 is formed on the first data line 171h, the second data line 171l, the first source electrode 173h, the first drain electrode 175h, and on an exposed portion of the first semiconductor 154h between the first source electrode 173h and the first drain electrode 175h. The passivation layer 180 is also formed on the second source electrode 173l, the second drain electrode 175l, and on an exposed portion of the second semiconductor 154l between the second source electrode 173l and the second drain electrode 175l. The passivation layer 180 may be formed of an organic insulating material or an inorganic insulating material. The passivation layer 180 may also be formed as a single layer or a multilayer structure.

Color filters 230 are formed on the passivation layer 180 within each of the pixels PXs. Each color filter 230 may display one of primary colors such as the three primary colors red, green, and blue. However, the color filter 230 is not limited to the three primary colors red, green, and blue. In some other embodiments, the color filter 230 may also display cyan, magenta, yellow, white-based colors, and the like.

A light blocking member 220 is formed in a region between adjacent color filters 230. The light blocking member 220 may be formed at a boundary between the plurality of pixel areas PXs and on the thin film transistors Qh and Ql, and between the first subpixel area PXa and the second subpixel area PXb. That is, the light blocking member 220 may be formed in the first valley V1 and the second valley V2. However, the position of the light blocking member 220 is not limited thereto. For example, in some other embodiments, the light blocking member 220 may be formed only in the first valley V1. The light blocking member 220 serves to prevent light leakage.

The color filter 230 and the light blocking member 220 may overlap each other in some regions. For example, the color filter 230 and the light blocking member 220 may overlap each other at the boundary between the first valley V1 and the first subpixel area PXa, and at the boundary between the first valley V1 and the second subpixel area PXb. FIGS. 5 and 6 illustrate the case in which the light blocking member 220 is formed on the color filter 230 in a region where the color filter 230 and the light blocking member 220 overlap each other. However, the inventive concept is not limited thereto. For example, in some other embodiments, the color filter 230 may be formed on the light blocking member 220 in a region where the color filter 230 and the light blocking member 220 overlap each other.

A first insulating layer 240 may be formed on the color filter 230 and the light blocking member 220. The first insulating layer 240 may be formed of an organic insulating material. The first insulating layer 240 may serve to planarize the color filters 230. In some particular embodiments, the first insulating layer 240 may be omitted.

A second insulating layer 250 may be formed on the first insulating layer 240. The second insulating layer 250 may be formed of an inorganic insulating material. The second insulating layer 250 may serve to protect the color filter 230. In some particular embodiments, the second insulating layer 250 may be omitted.

A first contact hole 181h and a second contact hole 181l are formed in the passivation layer 180, the color filter 230, the first insulating layer 240 and the second insulating layer 250. The first contact hole 181h exposes the wide end of the first drain electrode 175h and the second contact hole 181l exposes the wide end of the second drain electrode 175l.

A pixel electrode 191 is formed on the second insulating layer 250. The pixel electrode 191 may be formed of a transparent metal material, such as indium tin oxide (ITO) or indium zinc oxide (IZO).

The pixel electrode 191 includes a first subpixel electrode 191h and a second subpixel electrode 191l separated from each other, with the gate line 121 and the storage electrode line 131 disposed therebetween. The first subpixel electrode 191h and the second subpixel electrode 191l are disposed over and under the pixel PX with reference to the gate line 121 and the storage electrode line 131, and are adjacent to each other in a column direction. That is, the first subpixel electrode 191h and the second subpixel electrode 191l are separated from each other, with the first valley V1 disposed therebetween and the first subpixel electrode 191h located in the first subpixel PXa and the second subpixel electrode 191l located in the second subpixel PXb. However, it should be noted that the configuration of the first subpixel electrode 191h and the second subpixel electrode 191l is not limited thereto, and can be modified in different ways.

The first subpixel electrode 191h is connected to the first drain electrode 175h through the first contact hole 181h, and the second subpixel electrode 191l is connected to the second drain electrode 175l through the second contact hole 181l. When the first thin film transistor Qh and the second thin film transistor Ql are switched on, each of the first subpixel electrode 191h and the second subpixel electrode 191l is applied with a different data voltage from the first drain electrode 175h and the second drain electrode 175l. Subsequently, an electric field may be formed between the pixel electrode 191 and the first common electrode 270a.

Each of the first subpixel electrode 191h and the second subpixel electrode 191l may be formed as a quadrangle. Also, each of the first subpixel electrode 191h and the second subpixel electrode 191l includes a cruciform stem part comprising horizontal stem parts 193h and 193l and vertical stem parts 192h and 192l intersecting the horizontal stem parts 193h and 193l. Further, each of the first subpixel electrode 191h and the second subpixel electrode 191l includes a plurality of fine branch parts 194h and 194l.

The pixel electrode 191 is divided into four subregions by the horizontal stem parts 193h and 193l and the vertical stem parts 192h and 192l. The fine branch parts 194h and 194l extend obliquely from the horizontal stem parts 193h and 193l and the vertical stem parts 192h and 192l at an angle of approximately 45° or 135° with respect to the gate line 121 or the horizontal stem parts 193h and 193l. Furthermore, the fine branch parts 194h and 194l of two adjacent subregions may extend orthogonal to each other.

In some embodiments, each of the first subpixel electrode 191h and the second subpixel electrode 191l may further include an outside stem part surrounding the outside of the first subpixel PXa and second subpixel PXb.

It should be noted that the above-described configuration of the pixel, the structure of the thin film transistor, and the shape of the pixel electrode are merely exemplary, and that the inventive concept is not limited thereto and can be modified in different ways.

The first common electrode 270a is formed on the pixel electrode 191, and spaced apart from the pixel electrode 191 by a predetermined distance. A microcavity 305 is formed between the pixel electrode 191 and the first common electrode 270a. That is, the microcavity 305 is surrounded by the pixel electrode 191 and the first common electrode 270a.

The first common electrode 270a is formed in a row direction over the microcavity 305 and in a second valley V2. The first common electrode 270a may cover an upper surface and a side of the microcavity 305 so as to maintain a shape of the microcavity 305. Therefore, the shape of the microcavity 305 may be largely determined by the first common electrode 270a. The horizontal and vertical widths and a height of the microcavity 305 may be changed depending on a size and resolution of the display device.

As previously described, the first common electrode 270a is formed exposing a side of the edge of the microcavity 305. The portions where the microcavity 305 is not covered by the first common electrode 270a correspond to injection holes 307a and 307b. The injection holes 307a and 307b include a first injection hole 307a (which exposes a side of a first edge of the microcavity 305) and a second injection hole 307b (which exposes a side of a second edge of the microcavity 305). The first edge and the second edge of the microcavity 305 face each other. For example, the first edge may correspond to an upper edge of the microcavity 305 and the second edge may correspond to a lower edge of the microcavity 305. Since the microcavity 305 is exposed by the injection holes 307a and 307b, an aligning agent, a liquid crystal material, or the like may be injected into the microcavity 305 through the injection holes 307a and 307b.

The first common electrode 270a may be formed of a transparent metal material, such as indium tin oxide (ITO) or indium zinc oxide (IZO). A constant voltage may be applied to the first common electrode 270a so as to form an electric field between the pixel electrode 191 and the first common electrode 270a.

A first alignment layer 11 is formed on the pixel electrode 191. The first alignment layer 11 may also be formed on a portion of the second insulating layer 250 that is not covered by the pixel electrode 191.

A second alignment layer 21 is formed under the first common electrode 270a facing the first alignment layer 11.

The first alignment layer 11 and the second alignment layer 21 may be a vertical alignment layer, and may be formed of an alignment material such as polyamic acid, polysiloxane, or polyimide. The first and second alignment layers 11 and 21 may be connected to each other at a side wall on the edge of the microcavity 305.

The liquid crystal layer (including liquid crystal molecules 310) is disposed within the microcavity 305 between the pixel electrode 191 and the first common electrode 270a. The liquid crystal molecules 310 have a negative dielectric anisotropy and may align in a direction perpendicular to the substrate 110 in the absence of an electric field. As such, vertical alignment of the liquid crystal molecules may be realized.

An electric field is generated between the first common electrode 270a, and the first subpixel electrode 191h and the second subpixel electrode 191l (to which the data voltages are applied). The electric field controls the alignment direction of the liquid crystal molecules 310 located within the microcavity 305 between the two electrodes 191 and 270a. The luminance of light transmitting through the liquid crystal layer can vary depending on the alignment direction of the liquid crystal molecules 310.

A roof layer 360 is formed on the first common electrode 270a. The roof layer 360 is formed overlapping the first common electrode 270a at the edge of the microcavity 305. The roof layer 360 may be formed at the edge of the microcavity 305 where the injection holes 307a and 307b are formed. For example, the roof layer 360 may be formed at the upper edge and the lower edge of the microcavity 305. As previously described, the roof layer 360 is not formed at the central portion of the microcavity 305. The roof layer 360 may be formed of an inorganic insulating material such as silicon nitride (SiNx), silicon oxide (SiOx), and the like.

The encapsulation layer 390 is formed on the roof layer 360. The encapsulation layer 390 is formed covering the injection holes 307a and 307b and encapsulates the microcavity 305, so that the liquid crystal molecules 310 in the microcavity 305 do not leak to the outside. The encapsulation layer 390 is formed in the first valley V1 and may be formed overlapping the edge of the microcavity 305. In particular, the encapsulation layer 390 may be formed overlapping the edge of the microcavity 305 where the injection holes 307a and 307b are formed. The encapsulation layer 390 only overlaps the microcavity 305 at the edge of the microcavity 305. That is, the encapsulation layer 390 does not overlap the central portion of the microcavity 305.

The encapsulation layer 390 comes in contact with the liquid crystal molecules 310. Therefore the encapsulation layer 390 may be formed of a material that does not react with the liquid crystal molecules 310. For example, the encapsulation layer 390 may be formed of parylene and the like.

The encapsulation layer 390 may be formed as a multilayer structure (such as a double layer or a triple layer). The double layer may include two layers comprising of different materials. The triple layer includes three layers, whereby layers adjacent to each other are formed of different materials. For example, the encapsulating layer 390 may include a layer formed of an organic insulating material and another layer formed of an inorganic insulating material.

The second common electrode 270b is formed on the first common electrode 270a and the encapsulation layer 390. The second common electrode 270b may be formed over the entire surface of the substrate 110. However, in some particular embodiments, the second common electrode 270b is not formed on an edge region of the substrate 110.

The second common electrode 270b is connected to the first common electrode 270a. In some embodiments, the roof layer 360 and the encapsulation layer 390 only cover the first common electrode 270a in a first region on the edge of the microcavity 305, and do not cover the first common electrode 270a in the remaining regions of the microcavity 305. Therefore, the first common electrode 270a may be directly connected to the second common electrode 270b at a portion where the first common electrode 270a overlaps the microcavity 305.

The second common electrode 270b may be formed of a transparent metal material, such as indium tin oxide (ITO) or indium zinc oxide (IZO). A constant voltage may be applied to the second common electrode 270b. Also, the first common electrode 270a and the second common electrode 270b may be applied with a same voltage.

The plurality of first common electrodes 270a are formed in a row direction and are not formed in the first valley V1. Since the plurality of first common electrodes 270a are not connected to each other, the resistance of the first common electrode 270a may increase. To reduce the resistance of the first common electrode 270a, the first common electrode 270a is formed in a first region of the first valley V1 so as to connect first common electrodes 270a adjacent to each other. However, since the first common electrode 270a is not formed covering the injection holes 307a and 307b, the amount of resistance that can be reduced is limited. According to an exemplary embodiment of the inventive concept, the second common electrode 270b is formed over the entire surface of the substrate 110 and connected to the first common electrode 270a, which can further reduce the resistance of the first common electrode 270a and enable uniform luminance in the display device.

Although not illustrated in the drawings, polarizers may be further formed on the upper and lower surfaces of the display device. The polarizer may include a first polarizer and a second polarizer. The first polarizer may be attached to a lower surface of the substrate 110, and the second polarizer may be attached to an upper surface of the second common electrode 270b.

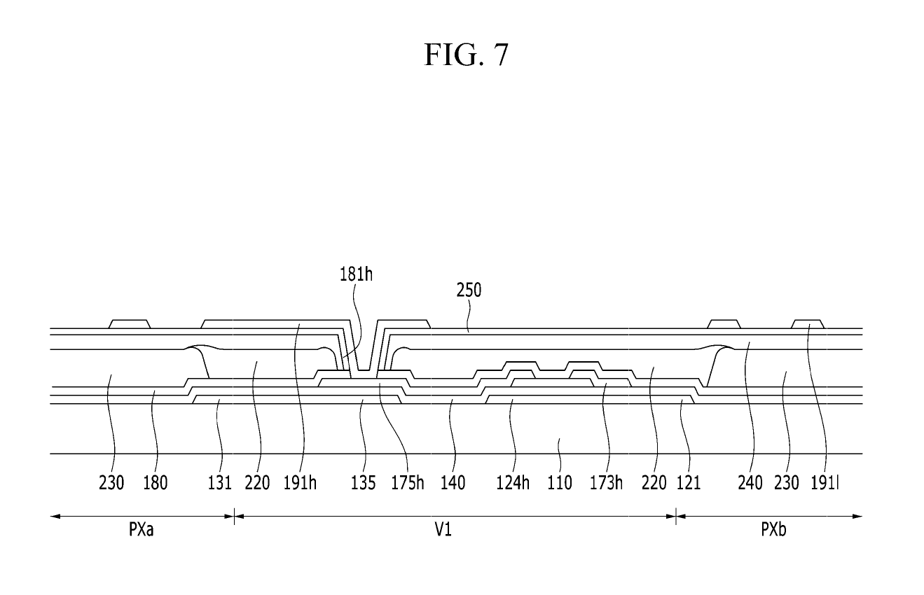

Next, an exemplary method of manufacturing a display device will be described in detail with reference to FIGS. 7 to 16 and the embodiments previously described in FIGS. 1 to 6.

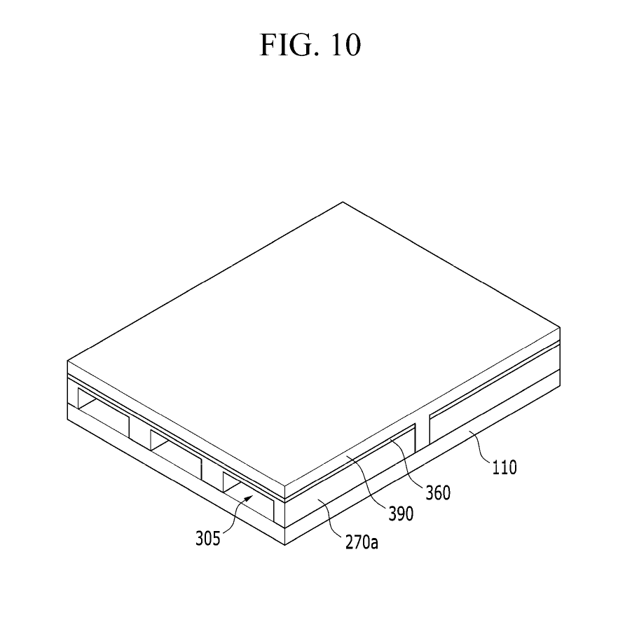

FIGS. 7 to 9 illustrate a method of manufacturing a display device according to an exemplary embodiment of the inventive concept. Specifically, FIGS. 7 to 9, 11, 13, and 15 are cross-sectional views of the display device, and FIGS. 10, 12, 14, and 16 are perspective views of the display device, at different stages of manufacture. To avoid obscuring the inventive concept, FIGS. 10, 12, 14, and 16 focus on some of the main components of the display device.

First, as illustrated in FIG. 7, the gate line 121, the first gate electrode 124h, and the second gate electrode 124l are formed on the substrate 110. The gate line 121 is formed extending in one direction, with the first gate electrode 124h and the second gate electrode 124l protruding from the gate line 121. The substrate 110 may be formed of glass, plastic, or the like. The gate electrode 124h and the second gate electrode 124l may be connected to each other so as to form a single protrusion.

In addition, the storage electrode line 131, and the storage electrodes 133 and 135 protruding from the storage electrode line 131, may be formed on the substrate 110 and spaced apart from the gate line 121. The storage electrode line 131 may extend in the same direction as the gate line 121. The storage electrode 133 protrudes over the storage electrode line 131 and surrounds the edge of the first subpixel area PXa. The storage electrode 135 protrudes under the storage electrode line 131 and may be adjacent to the first gate electrode 124h and the second gate electrode 124l.

Next, the gate insulating layer 140 is formed on the gate line 121, the first gate electrode 124h, the second gate electrode 124l, the storage electrode line 131, and the storage electrodes 133 and 135. The gate insulating layer 140 may be formed of an inorganic insulating material such as silicon nitride (SiNx) or silicon oxide (SiOx). The gate insulating layer 140 may be formed as a single layer or a multilayer structure.

Next, a semiconductor material (such as amorphous silicon, polycrystalline silicon, or metal oxide) is deposited on the gate insulating layer 140 and subsequently patterned to form the first semiconductor 154h and the second semiconductor 154l. The first semiconductor 154h may be disposed on the first gate electrode 124h, and the second semiconductor 154l may be disposed on the second gate electrode 124l.

Next, the first data line 171h and the second data line 171l are formed extending in another direction perpendicular to the gate line 121. The first data line 171h and the second data line 171l are formed by depositing a metal material and subsequently patterning the metal material. The metal material may be formed as a single layer or a multilayer structure.

The first source electrode 173h and the first drain electrode 175h are formed together. The first source electrode 173h protrude over the first gate electrode 124h from the first data line 171h, and is spaced apart from the first drain electrode 175h. Also, the second source electrode 173l and the second drain electrode 175l are formed together. The second source electrode 173l protrudes over the second gate electrode 124l from the second data line 171l, and is spaced apart from the second drain electrode 175l.

The first and second semiconductors 154h and 154l, the first and second data lines 171h and 171l, the first and second source electrodes 173h and 173l, and the first and second drain electrodes 175h and 175l may be formed by repeatedly depositing and patterning the semiconductor material and the metal material. In some embodiments, the first semiconductor 154h is also formed under the first data line 171h and the second semiconductor 154l is also formed under the second data line 171l.

The first and second gate electrodes 124h and 124l, the first and second source electrodes 173h and 173l, the first and second drain electrodes 175h and 175l, together with the first and second semiconductors 154h and 154l, collectively constitute the first and second thin film transistors (TFTs) Qh and Ql, respectively.

Next, the passivation layer 180 is formed on the first data line 171h, the second data line 171l, the first source electrode 173h, the first drain electrode 175h, on an exposed portion of the first semiconductor 154h between the first source electrode 173h and the first drain electrode 175h, the second source electrode 173l, the second drain electrode 175l, and on an exposed portion of the second semiconductor 154l between the second source electrode 173l and the second drain electrode 175l. The passivation layer 180 may be formed of an organic insulating material or an inorganic insulating material. The passivation layer 180 may be formed as a single layer or a multilayer structure.

Next, the color filter 230 is formed on the passivation layer 180. The color filter 230 is formed within the first subpixel PXa and the second subpixel PXb, and is not formed in the first valley V1. Color filters 230 having a same color may be formed along the column direction of the plurality of pixel areas PXs. In forming color filters 230 comprising of three colors, a color filter 230 of a first color is first formed, and a color filter 230 of a second color is then formed by mask shifting. After the color filter 230 of the second color is formed, the mask is again shifted to form a color filter 230 of a third color.

Next, the light blocking member 220 is formed in the first valley V1 and the second valley V2.

The color filter 230 and the light blocking member 220 may be formed overlapping each other in some regions. For example, the color filter 230 and the light blocking member 220 may be formed overlapping each other at the boundary between the first valley V1 and the first subpixel area PXa, and at the boundary between the first valley V1 and the second subpixel area PXb.

In the above-described embodiments, the color filter 230 is formed prior to forming the light blocking member 220. However, the inventive concept is not limited thereto. For example, in some other embodiments, the light blocking member 220 may be formed prior to forming the color filter 230.

Next, the first insulating layer 240 is formed on the color filter 230 and the light blocking member 220, and the second insulating layer 250 is formed on the first insulating layer 240. The first insulating layer 240 may be formed of an organic insulating material, and the second insulating layer 250 may be formed of an inorganic insulating material.

The first contact hole 181h and the second contact hole 181l are formed by patterning the passivation layer 180, the color filter 230, the first insulating layer 240, and the second insulating layer 250. The first contact hole 181h expose at least a portion of the first drain electrode 175h, and the second contact hole 181l expose at least a portion of the second drain electrode 175l. In some embodiments, the passivation layer 180, the color filter 230, the first insulating layer 240, and the second insulating layer 250 may be simultaneously patterned. In some other embodiments, each of the passivation layer 180, the color filter 230, the first insulating layer 240, and the second insulating layer 250 may be patterned separately. In some further embodiments, some of the passivation layer 180, the color filter 230, the first insulating layer 240, and the second insulating layer 250 may be simultaneously patterned (while the remaining layers are patterned separately).

A transparent metal material (such as indium tin oxide (ITO) or indium zinc oxide (IZO)) is deposited on the second insulating layer 250 and subsequently patterned, thereby forming the pixel electrode 191 within the pixel area PX. The pixel electrode 191 includes the first subpixel electrode 191h (which is located within the first subpixel area PXa) and the second subpixel electrode 191l (which is located within the second subpixel area PXb). The first subpixel electrode 191h and the second subpixel electrode 191l may be separated from each other with the first valley V1 disposed therebetween.

Each of the first subpixel electrode 191h and the second subpixel electrode 191l includes the horizontal stem parts 193h and 193l and the vertical stem parts 192h and 192l intersecting the horizontal stem parts 193h and 193l. Furthermore, the plurality of fine branch parts 194h and 194l are formed extending obliquely from the horizontal stem parts 193h and 193l and the vertical stem parts 192h and 192l.

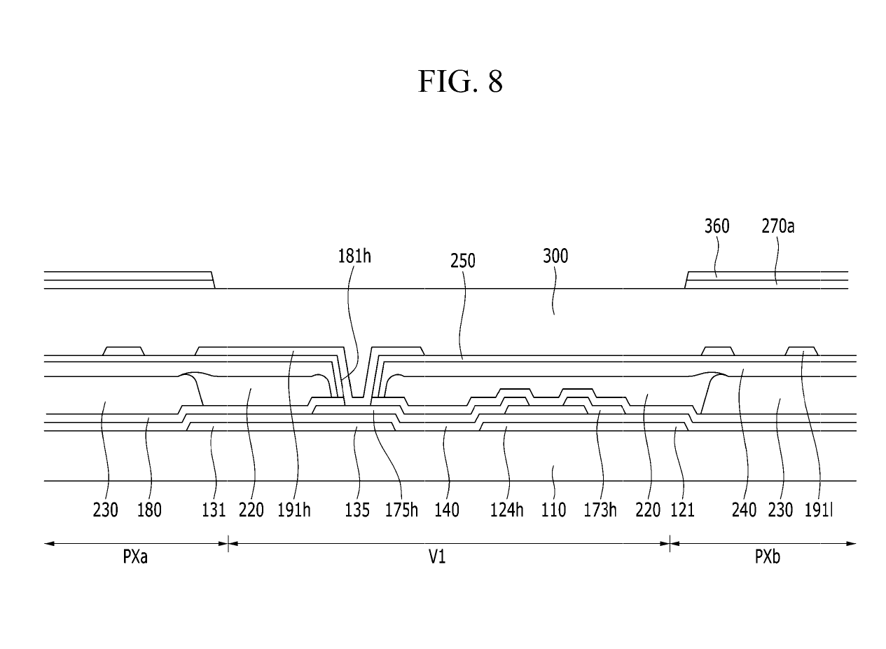

As illustrated in FIG. 8, a photosensitive organic material is applied on the pixel electrode 191 and a sacrificial layer 300 is formed using a photolithography process. The sacrificial layer 300 may be formed in a column direction. The sacrificial layer 300 may be formed in each of the pixels PXs and the first valley V1, and is not formed in the second valley V2.

Next, the first common electrode 270a is formed by depositing a transparent metal material (such as indium tin oxide (ITO) or indium zinc oxide (IZO)) on the sacrificial layer 300.

Next, the roof layer 360 is formed on the first common electrode 270a. The roof layer 360 may be formed of an inorganic insulating material such as silicon oxide or silicon nitride.

Next, portions of the roof layer 360 and the first common electrode 270a located in the first valley V1 are removed by patterning the roof layer 360 and the first common electrode 270a. Accordingly, the plurality of roof layers 360 and the plurality of first common electrodes 270a are formed in a row direction, and adjacent first common electrodes 270a are not connected to each other.

A portion of the sacrificial layer 300 is exposed by patterning the roof layer 360 and the first common electrode 270a. A developer, a stripper solution, or the like may be applied on the substrate 110 where the sacrificial layer 300 is exposed, so as to completely remove the sacrificial layer 300. In some embodiments, the sacrificial layer 300 may be completely removed by an ashing process.

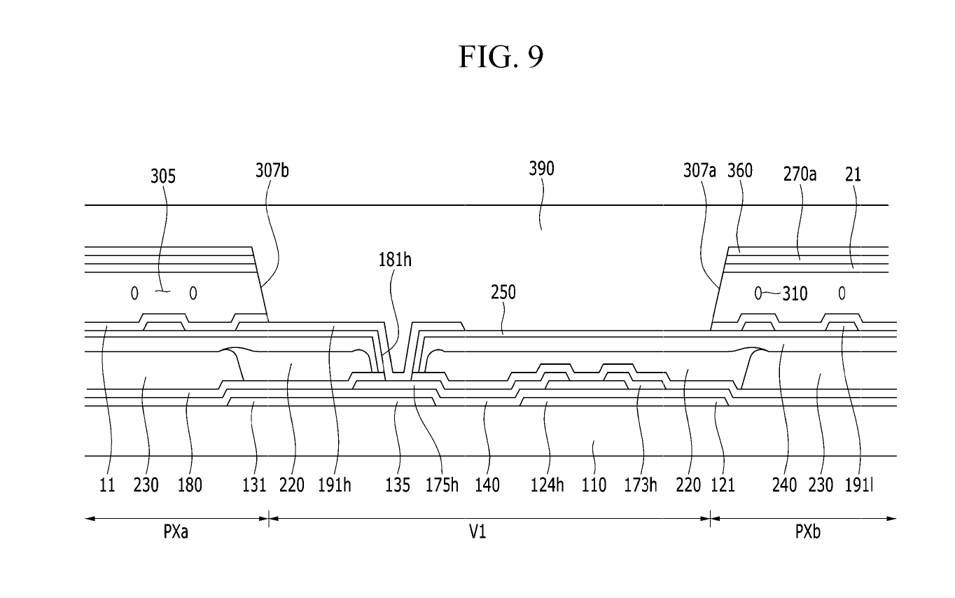

As illustrated in FIGS. 9 and 10, when the sacrificial layer 300 is removed, the microcavity 305 is thus formed in the region where the sacrificial layer 300 was previously located.

The pixel electrode 191 and the first common electrode 270a are spaced apart from each other with the microcavity 305 disposed therebetween. The first common electrode 270a is formed covering an upper surface and both sides of the microcavity 305.

An edge portion of the microcavity 305 is not covered by the first common electrode 270a and is therefore exposed. The portions where the microcavity 305 is exposed correspond to the injection holes 307a and 307b. A microcavity 305 may be formed with two injection holes 307a and 307b. For example, the microcavity 305 may be formed with the first injection hole 307a exposing a side on the first edge of the microcavity 305 and the second injection hole 307b exposing a side on the second edge of the microcavity 305. The first edge and the second edge of the microcavity 305 may face each other. For example, the first edge may correspond to an upper edge of the microcavity 305 and the second edge may correspond to a lower edge of the microcavity 305.

Next, an aligning agent including an aligning material may be dispensed on the substrate 110 by a spin coating method or an inkjet method, and subsequently injected into the microcavity 305 through the injection holes 307a and 307b. After the aligning agent is injected into the microcavity 305, a hardening process is performed to evaporate the solvent in the aligning agent, so as to leave the aligning material on a wall surface of the microcavity 305.

Accordingly, the first alignment layer 11 is formed on the pixel electrode 191, and the second alignment layer 21 may be formed beneath the first common electrode 270a. The first alignment layer 11 and the second alignment layer 21 face each other with the microcavity 305 disposed therebetween. The first alignment layer 11 and the second alignment layer 21 may be connected to each other at the edge of the microcavity 305.

In some embodiments, the first and second alignment layers 11 and 21 may be aligned in a vertical direction perpendicular to the substrate 110 (except at the sides of the microcavity 305).

Next, a liquid crystal material is dispensed on the substrate 110 by an inkjet method or a dispensing method, and injected into the microcavity 305 through the injection holes 307a and 307b via capillary force.

Next, the encapsulation layer 390 is formed on the roof layer 360 by depositing a material which does not react with the liquid crystal molecules 310. The encapsulation layer 390 is formed covering the injection holes 307a and 307b and encapsulates the microcavity 305, so that the liquid crystal molecules 310 in the microcavity 305 do not leak to the outside.

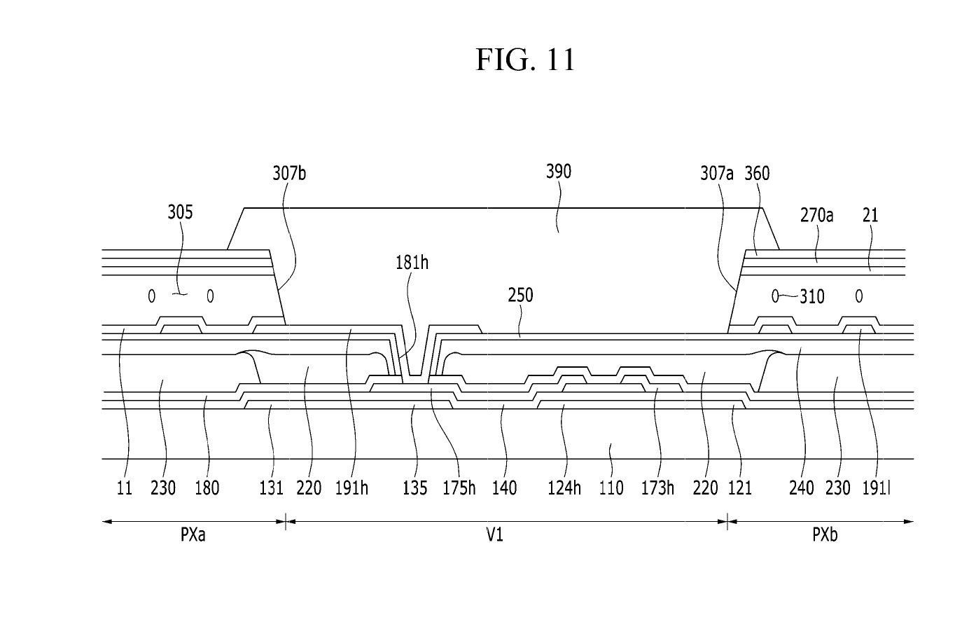

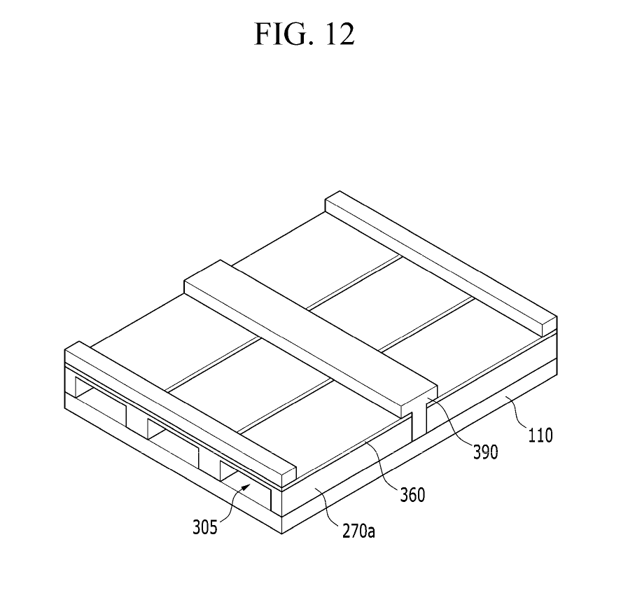

As illustrated in FIGS. 11 and 12, a significant portion of the encapsulation layer 390 overlapping the microcavity 305 is removed by patterning the encapsulation layer 390. Nevertheless, a portion of the encapsulation layer 390 overlapping the edge of the microcavity 305 and the encapsulation layer 390 in the first valley V1 may remain. In particular, the portion of the encapsulation layer 390 overlapping the edge of the microcavity 305 (where the injection holes 307a and 307b are formed) may remain. The encapsulation layer 390 does not overlap the microcavity 305 other than at the edge of the microcavity 305. That is, the encapsulation layer 390 does not overlap the central portion of the microcavity 305.

The encapsulation layer 390 may be formed of a material including a photosensitive organic material. A mask is placed on the encapsulation layer 390 and when light is irradiated through the mask, the photosensitive organic material reacts to the light. Accordingly, the encapsulation layer 390 may be patterned by a photolithography process. Nevertheless, the encapsulation layer 390 may be patterned using other methods. In some other embodiments, a photosensitive layer is formed on the encapsulation layer 390, and the photosensitive layer is then patterned by a photolithography process. Subsequently, the encapsulation layer 390 may be etched using the patterned photosensitive layer.

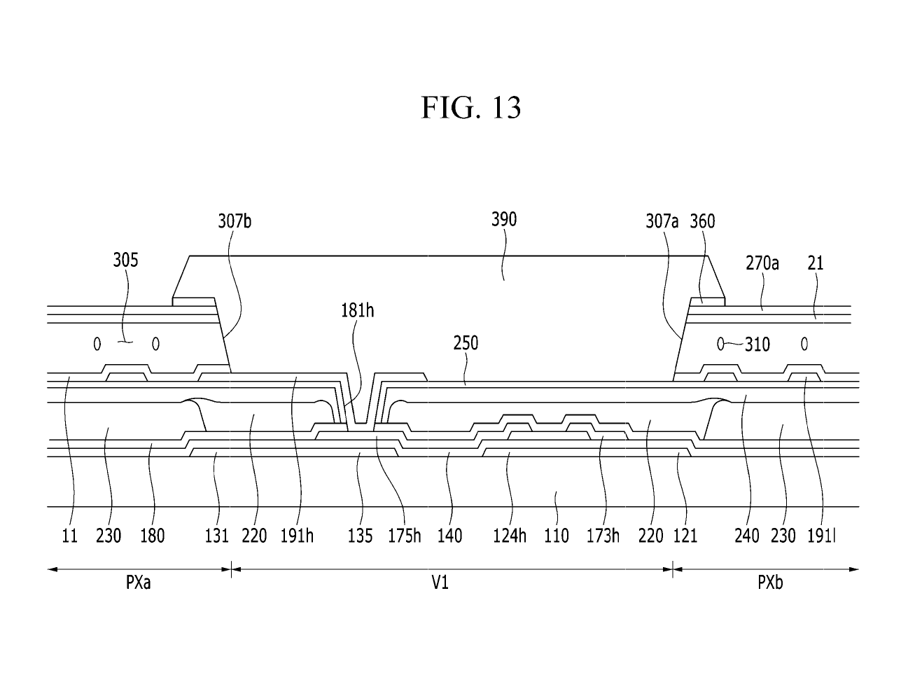

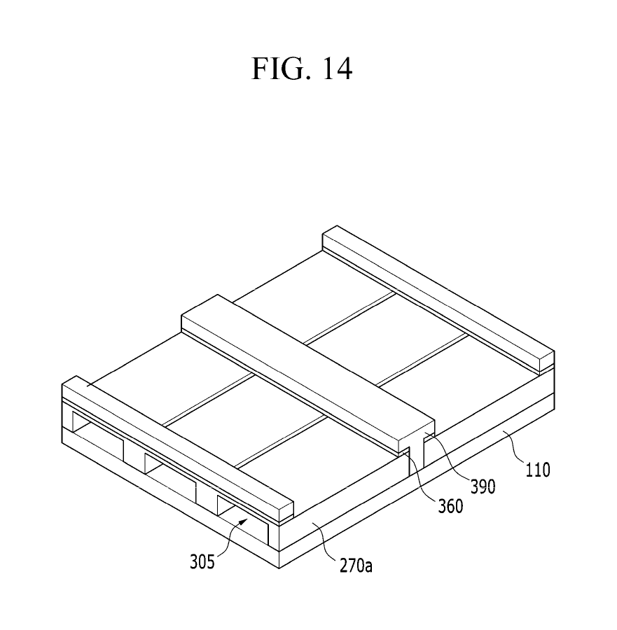

As illustrated in FIGS. 13 and 14, the roof layer 360 is patterned using the patterned encapsulation layer 390 as a mask. A significant portion of the roof layer 360 overlapping the microcavity 305 is removed while a portion of the roof layer 360 overlapping the edge of the microcavity 305 remains. The roof layer 360 is located between the first common electrode 270a and the encapsulation layer 390.

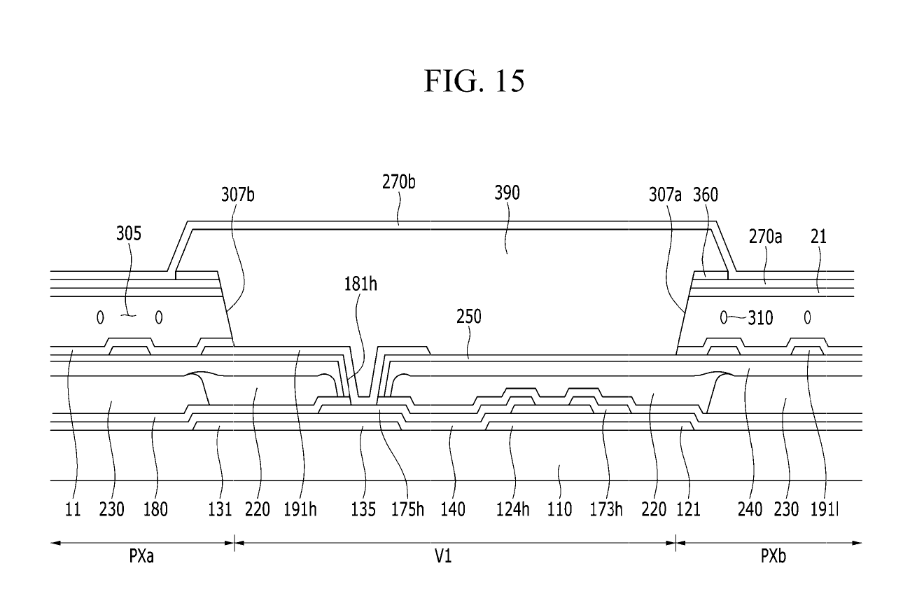

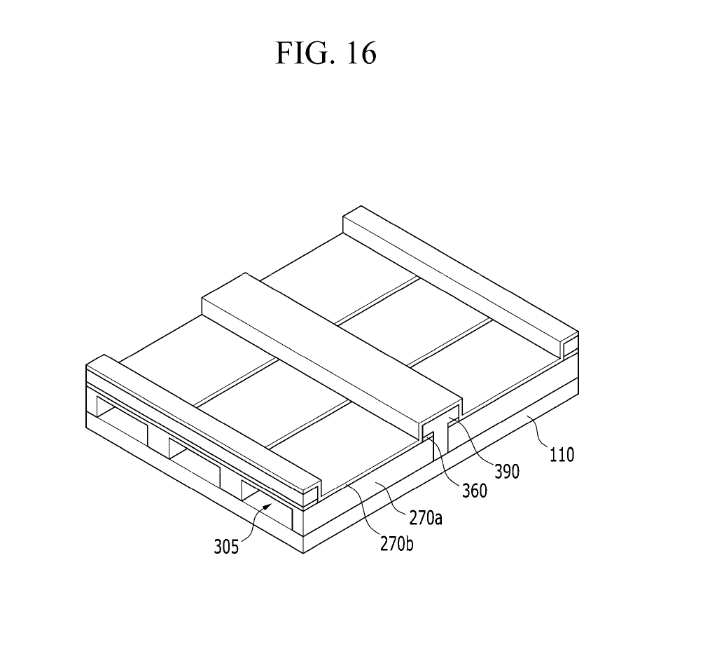

As illustrated in FIGS. 15 and 16, the second common electrode 270b is formed on the first common electrode 270a and the encapsulation layer 390. The second common electrode 270b may be formed of a transparent metal material such as indium tin oxide (ITO) or indium zinc oxide (IZO). The second common electrode 270b may be formed over the entire surface of the substrate 110. However, in some embodiments, the second common electrode 270b may be patterned such that the second common electrode 270b is not formed in a region on an edge of the substrate 110. Circuit units (such as a gate driver or a data driver) or pad parts connected thereto may be formed in the region on the edge of the substrate 110 (where the second common electrode 270b is not formed).

The first common electrode 270a is exposed by removing the portions of the roof layer 360 and the encapsulation layer 390 overlapping the microcavity 305 (other than those portions at the edge of the microcavity 305). The second common electrode 270b is formed on the first common electrode 270a and therefore the first common electrode 270a and the second common electrode 270b are directly connected to each other. The first common electrode 270a and the second common electrode 270b are connected to each other in the portion of the first common electrode 270a and the second common electrode 270b overlapping the microcavity 305. A same voltage may be applied to the first common electrode 270a and the second common electrode 270b.

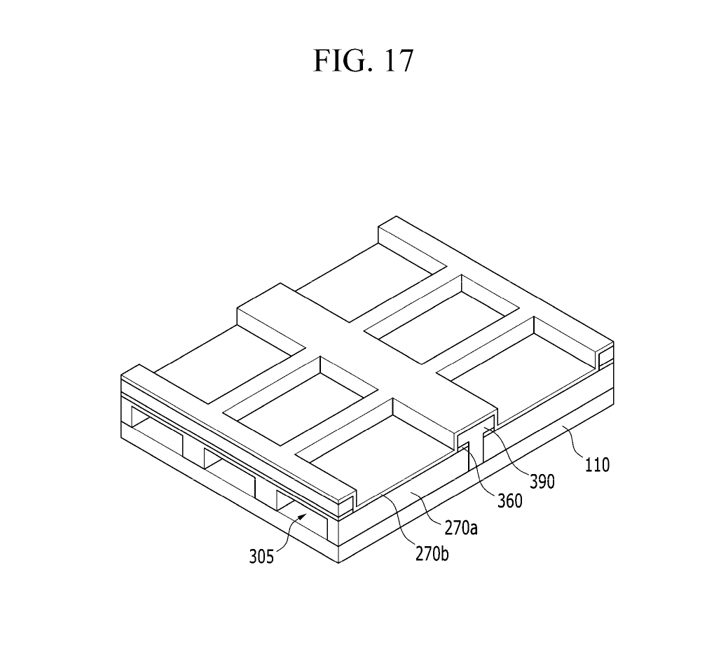

Next, a display device according to another exemplary embodiment of the inventive concept will be described with reference to FIGS. 17 to 19.

The display device illustrated in FIGS. 17 to 19 and the display device illustrated in FIGS. 1 to 6 share similar aspects, and therefore a description of the same elements shall be omitted. The embodiment in FIGS. 17 to 19 is different from the previously-described embodiments in that the encapsulation layer (in FIGS. 17 to 19) is formed having a net shape, which will be described below in more detail.

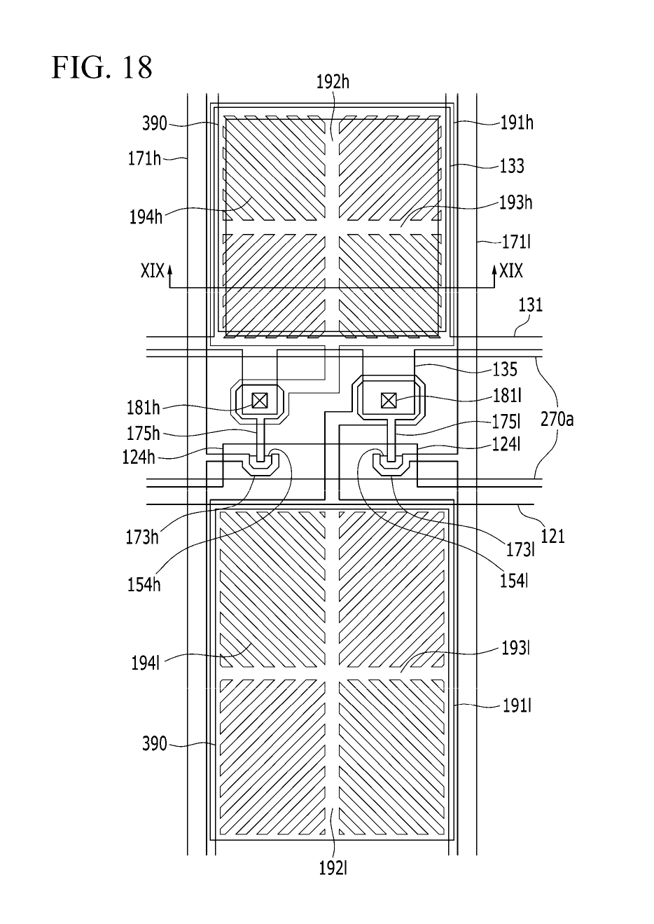

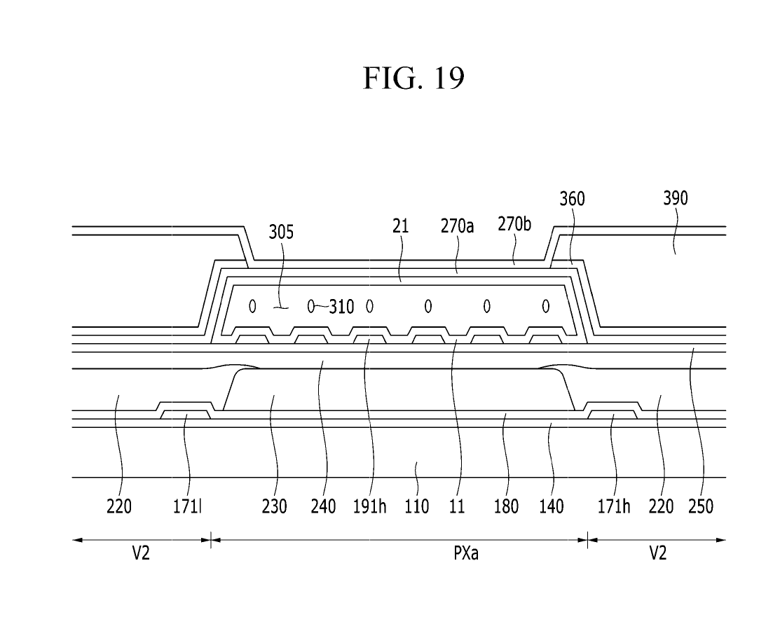

FIG. 17 is a perspective view of a display device according to another exemplary embodiment of the inventive concept; FIG. 18 is a plan view of the display device of FIG. 17; and FIG. 19 is a cross-sectional view of the display device of FIG. 18 taken along line XIX-XIX.

In the embodiment of FIGS. 1 to 6, the encapsulation layer 390 is formed in a bar shape extending in a column direction. In contrast, the encapsulation layer 390 in FIGS. 17 to 19 is formed having a net shape extending in both the column direction and the row direction.

Referring to FIGS. 17 to 19, the encapsulation layer 390 covers the injection holes 307a and 307b so as to encapsulate the microcavity 305. The encapsulation layer 390 is formed in the first valley V1 and the second valley V2, and may be formed overlapping the edge of the microcavity 305. The encapsulation layer 390 may overlap all four edges of the microcavity 305. The encapsulation layer 390 only overlaps the microcavity 305 at the edge of the microcavity 305. In particular, the encapsulation layer 390 does not overlap the central portion of the microcavity 305.

Since the encapsulation layer 390 is formed in the second valley V2, the roof layer 360 may also be formed in the second valley V2. In the embodiment of FIGS. 1 to 6, the roof layer 360 located in the second valley V2 is removed. In contrast, in the embodiment of FIGS. 17 to 19, the roof layer 360 located in the second valley V2 remains.

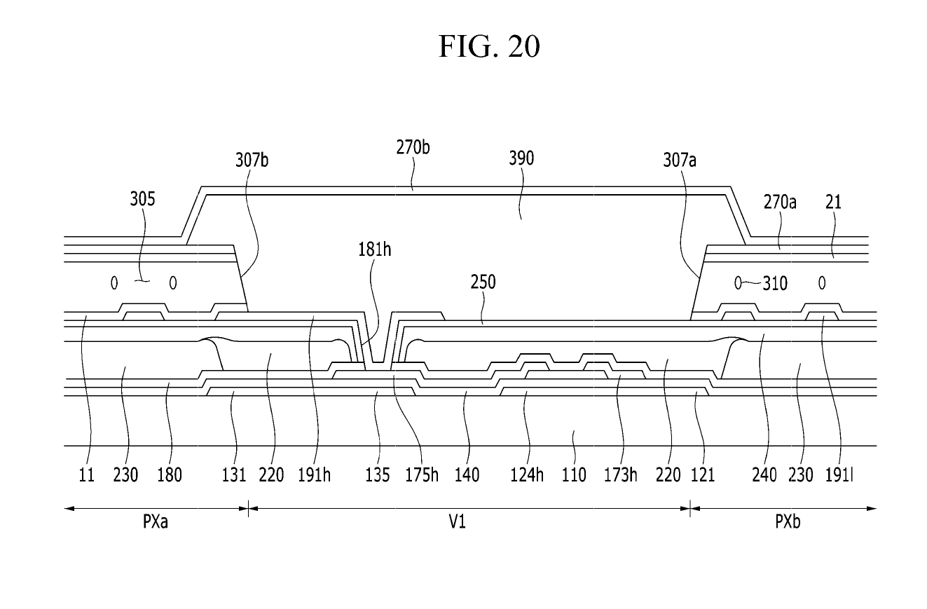

Next, a display device according to a further exemplary embodiment of the inventive concept will be described below with reference to FIG. 20.

The display device illustrated in FIG. 20 and the display device illustrated in FIGS. 1 to 6 share similar aspects and therefore a description of the same elements shall be omitted. The embodiment in FIG. 20 is different from the previously-described embodiments in that the roof layer (in FIG. 20) is omitted, as described in more detail below.

FIG. 20 is a cross-sectional view of a display device according to a further exemplary embodiment of the inventive concept.

In the previously-described embodiments, the roof layer 360 is formed between the first common electrode 270a and the encapsulation layer 390. In contrast, a roof layer is not formed in the embodiment of FIG. 20.

Referring to FIG. 20, the encapsulation layer 390 is formed on the first common electrode 270a at the edge of the microcavity 305. Since the roof layer is omitted, manufacturing costs and time may be further reduced.

While the inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the present disclosure.

What is claimed is:

1. A display device, comprising:
a substrate;
a thin film transistor disposed on the substrate;
a pixel electrode connected to the thin film transistor;
a first common electrode disposed on the pixel electrode, and spaced apart from the pixel electrode with a microcavity disposed therebetween;
an injection hole exposing a portion of the microcavity;
a liquid crystal layer filling the microcavity;
an encapsulation layer covering the injection hole so as to encapsulate the microcavity; and
a second common electrode disposed on the first common electrode and the encapsulation layer, wherein the second common electrode is connected to the first common electrode.

2. The display device of claim 1, wherein:
the microcavity is disposed in a matrix to form a plurality of microcavities,
a first valley is formed between the micro cavities adjacent to each other in a column direction, and
a second valley is formed between the micro cavities adjacent to each other in a row direction.

3. The display device of claim 2, wherein the encapsulation layer is disposed in the first valley.

4. The display device of claim 3, wherein the encapsulation layer is disposed overlapping an edge of the microcavity.

5. The display device of claim 4, wherein the encapsulation layer does not overlap the microcavity other than the edge of the microcavity.

6. The display device of claim 3, wherein the encapsulation layer does not overlap a central portion of the microcavity.

7. The display device of claim 3, wherein the first common electrode and the second common electrode are connected to each other at a portion overlapping the microcavity.

8. The display device of claim 3, wherein the encapsulation layer is disposed in the second valley.

9. The display device of claim 3, further comprising:
a roof layer disposed between the first common electrode and the encapsulation layer.

10. The display device of claim 9, wherein the roof layer includes at least one of silicon nitride and silicon oxide.

11. A method of manufacturing a display device, comprising:
forming a thin film transistor on a substrate;
forming a pixel electrode, wherein the pixel electrode is connected to the thin film transistor;
forming a sacrificial layer on the pixel electrode;
forming a first common electrode on the sacrificial layer;
patterning the first common electrode so as to expose a portion of the sacrificial layer;
forming a microcavity by removing the sacrificial layer, wherein a portion of the microcavity is exposed between the common electrode and the pixel electrode;
forming a liquid crystal layer by injecting a liquid crystal material into the microcavity through the exposed portion of the microcavity;
forming an encapsulation layer to cover the exposed portion of the microcavity, so as to encapsulate the microcavity;
patterning the encapsulation layer to expose at least a portion of the first common electrode; and
forming a second common electrode on the first common electrode and the encapsulation layer.

12. The method of claim 11, wherein:
the microcavity is disposed in a matrix to form a plurality of microcavities,
a first valley is formed between the micro cavities adjacent to each other in a column direction, and
a second valley is formed between the micro cavities adjacent to each other in a row direction.

13. The method of claim 12, wherein the encapsulation layer is patterned such that a portion of the encapsulation layer located in the first valley remains.

14. The method of claim 13, wherein the encapsulation layer is patterned such that a portion of the encapsulation layer overlapping an edge of the microcavity remains.

15. The method of claim 14, wherein the encapsulation layer is patterned to remove a portion of the encapsulation layer overlapping the microcavity, other than the portion of the encapsulation layer overlapping the edge of the microcavity.

16. The method of claim 13, wherein the encapsulation layer is patterned to remove a portion of the encapsulation layer overlapping a central portion of the microcavity.

17. The method of claim 13, wherein the first common electrode and the second common electrode are connected to each other at a portion overlapping the microcavity.

18. The method of claim 13, wherein the encapsulation layer is patterned such that a portion of the encapsulation layer located in the second valley remains.

19. The method of claim 13, further comprising:
forming a roof layer on the first common electrode;
patterning the roof layer to expose a portion of the sacrificial layer; and
patterning the roof layer by using the patterned encapsulation layer as a mask.

20. The method of claim 19, wherein the roof layer includes at least one of silicon nitride and silicon oxide.
